(19) United States
(12) Patent Application Publication
(10) Pub. No.: US 2020/0281793 A1
(43) Pub. Date: Sep. 10, 2020

(54) Apparatus for Increasing Blood Flood to the Feet

(71) Applicant: Reuven Moshe Zada, Karmiel (IL)

(72) Inventor: Reuven Moshe Zada, Karmiel (IL)

(21) Appl. No.: 16/799,968

(22) Filed: Feb. 25, 2020

(30) Foreign Application Priority Data
Mar. 5, 2019 (IL) 265167

(51) Int. Cl. A61H 1/00

(52) U.S. Cl. CPC A61H 1/005; A61H 2201/1207; A61H 2201/0149; A61H 2205/12; A61H 2201/1463; A61H 2201/1673

(57) ABSTRACT

An apparatus for increasing blood flood to the feet that includes a base, a plate, an electric motor and a control system. The palate is axially connected to the base with a gradient between 20 to 45 degrees that enables it to rotate while the front part of the plate is higher than its rear part. The electric motor is designed to rotate the plate. The plate includes a fastener for attaching the feet. The axial connection serves as a rotation axis point of the plate and the distance between the feet center point to the rotation axis point is between 6 to 15 centimeters. The control system controls the operation of the motor so that the rotation speed of the plate is cyclically changed so that the first part of each rotation is at a different speed than the second part of the rotation.

### TECHNICAL FIELD

The present invention refers to an apparatus for increasing blood flood to the feet.

### BACKGROUND ART

Many people with diabetes and with other kinds of sickens experience discomfort in their legs and feet, with symptoms such as cramping, numbness, tingling, and pain, that occurs due to poor blood circulation and flood to the feet and lower part of the legs. Many treatments are available to relieve these pain and discomfort, such as drugs, sports and massage that aimed to improve blood flow to the feet. The present invention discloses an apparatus that provide good solution to this problem.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 illustrates a user sitting on the compatible chair (6) and using the apparatus (1).

FIG. 2 illustrates the base (2), the plate (3), the electric motor (4) and the rotational motor shaft (41) that serves also as the axial connection (31).

FIG. 3 illustrates the plate (3) its parts and points.

### THE INVENTION

The main object of the present invention is to provide an apparatus for increasing blood flood and circulation to the feet. The apparatus (1) can be used without the assistance of a professional. The apparatus (1) causes the blood to flow in increased quantity to the feet for a very short period of time, and immediately after that enables the blood from the feet to circulate by the normal body function, ie back from the feet to the upper part of the legs and body, for a very short period of time, and repeatedly, and by that increase the blood circulation in the feet.

The apparatus (1) includes a base (2), a plate (3), electric motor (4) and a control system (5). The apparatus may also include a compatible chair (6) on which the user can sit while using the apparatus. The palate (3) is connected to the base (2) by an axial connection (31) that enables the plate to rotate, in a way that the center of the rotation is the axial connection (31). The electric motor (4) is connected to the plate (3) and rotates it. The rotational motor shaft (41) of the electric motor (4) can serves as the axial connection (31) of the plate (3) to the base (2).

The plate (3) is connected to the base (2) with a gradient, preferably between 20 to 45 degrees, so that the front part of the plate is always higher than the rear part, even when the plate rotates. The gradient degree may be controlled and changed by the control system (5). The terms front part and rear part can be replaced, and they are simply meant to illustrate that there is one side higher and one side lower.

The plate (3) includes a fastener (32) for attaching the feet (101) of the user (100) to the plate while in use. The fastener (32) may be in a kind of strips, niche or any other means that used for attaching foot to a plate. When using the apparatus (1) the user (100) can sit on the compatible chair (6), which is not connected to the plate (3), means that the chair (6) is not rotates, and the feet (101) of the user are attached to the plate by the fasteners (32). In this manner the feet are close to the user and then far from him or her, repeatedly, while the plate rotates. It is preferably that the fasteners (32) will be adjustable for various sizes and be attached to the plate (3) by an axial connection, so that the feet of the user will always be oriented forward without facing to the sides.

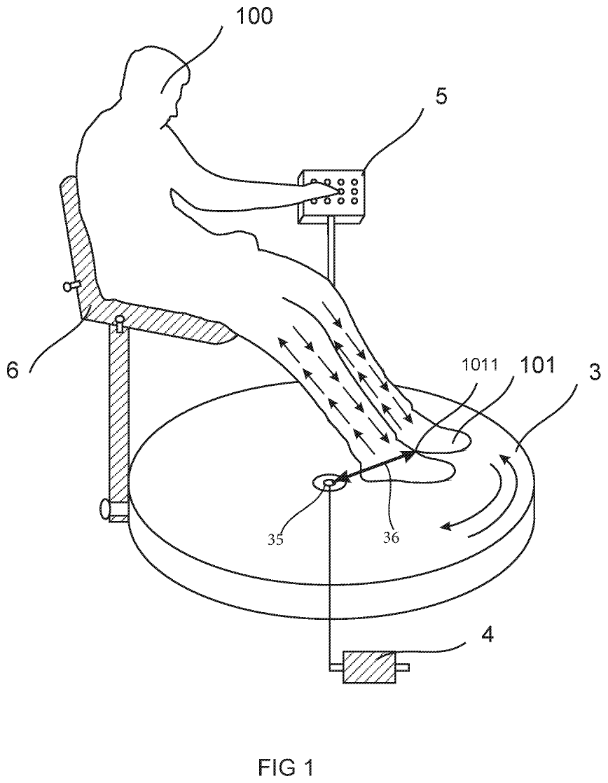

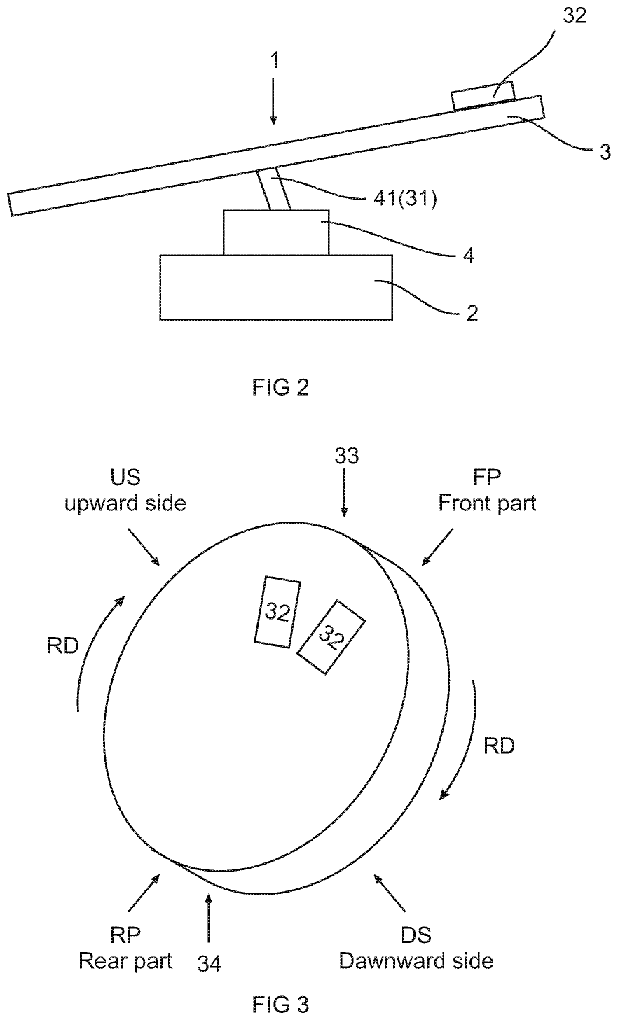

FIG. 1 illustrates the user sitting on the compatible chair (6) while using the apparatus (1). FIG. 2 illustrates the base (2), the plate (3), the electric motor (4) and the rotational shaft (41) that serves also as the axial connection (31).

The control system (5) controls the operation of the apparatus (1). For fluent explanation as to the operation of the apparatus (1) we will refer to FIG. 3 that illustrate the plate (3) wherein the front part (FP) of it is highest point of the plate and its rear part (RP) is the lowest point. Arrows RD show the rotational direction of the plate (3). The half side of the plate from point FP to point RP with the rotational direction is marked as DS, means downward side of the plate, and the other half of the plate from point RP to point FP with the rotational direction is marked as US, means upward side of the plate.

The electric motor (4) rotates the plate (3) in a way that the rotation speed is cyclically changed so that a first part (33) of each rotation will be at a faster speed and a second part (34) of the rotation will be lower, relatively. By that, when the rotation is faster the blood will stream to the feet by the inertia power and when the rotation is relatively slow the body can stream back the blood from the feet to the upper part of the legs and the body. By that, the apparatus increases the blood circulation to the feet. It is possible that the speed rotation will be faster when the feet are in the front area of the plate and slowly when the feet are in the rear part.

The apparatus (1) causes an increased flow of blood to the feet for a very short period of time, and then the rotation speed of the plate (3) decreases so that the body can perform a natural circulation process, and the blood flows back from the feet to the upper legs and the body, and so on, creating a healthy blood circulation for the feet.

The axial connection (31) point serves in fact also as the rotation axis point (35) of the plate (3). It is preferably that the distance (36) between the feet center point (1011), which is located between the left foot to the right foot in the middle of them when they are adjusted one to each other, to the rotation axis point (35) should be 6 to 15 centimeters. Experiments that the inventor has made show that the flow of blood to the feet is efficiently when the average rotational speed of the plate (3) is at least 40 revolutions per minute.

The compatible chair (6) may be adjustable so that it tilts and inclines according the rotation of the plate (3) and the position of the feet on the plate and by that makes it more comfortable for the user to use the apparatus (1).

What is claimed is:

1. An apparatus for increasing blood flood to feet of a user, comprising: a base, a plate, an electric motor and a control system;
wherein the palate is connected to the base by an axial connection that enables the plate to rotate; wherein the palate is connected to the base with a gradient between 20 to 45 degrees so that a front part of the plate is higher than a rear part of the plate;
wherein the electric motor is connected to the plate and is designed to rotate the plate; wherein said plate includes a fastener which is designed to attach the feet of the user to the plate;
wherein said axial connection serves as a rotation axis point of the plate and a distance between a feet center point to the rotation axis point is between 6 to 15 centimeters;
wherein the control system is designed to control the operation of the motor so that a rotation speed of the plate is cyclically changed so that a first part of each rotation can be at a different speed than a second part of said rotation; and
whereby when the user attach his or her feet to the plate and the plate is rotating at average speed of at least 40 revolutions per minute then while the plate is rotating then blood can stream to the feet by inertia power and circulate by the natural circulation process of the body when the rotational speed is lowered.
